(19) United States
(12) Patent Application Publication
(10) Pub. No.: US 2015/0048222 A1
(43) Pub. Date: Feb. 19, 2015

(54) LINE GUIDE AND METHODS OF USE

(71) Applicant: Eley Corporation, Lincoln, NE (US)

(72) Inventors: Craig D. Eley, Lincoln, NE (US); Darin Schollmeyer, Creighton, NE (US)

(21) Appl. No.: 14/460,467

(22) Filed: Aug. 15, 2014

Related U.S. Application Data
(60) Provisional application No. 61/866,899, filed on Aug. 16, 2013.

(51) Int. Cl. B05B 15/06; A01G 25/00

(52) U.S. Cl. CPC B05B 15/062; A01G 25/00
USPC 248/87

(57) ABSTRACT

A line guide includes an enclosure end portion and a mounting end portion. Guide balls are rotatably positioned along an open passage of the enclosure end portion. The mounting end portion can include an elongated mounting post and a separate base portion, having an open interior that is shaped to releasably receive the mounting post. The base portion is driven into the ground and the mounting post of the line guide is removably and rotatably disposed within the base portion. A line is pulled through the open passage along a pathway around obstacles adjacent to the line guide. When use of the line is complete, the line guides are removed from the base portions, which are left in the ground for future use.

### CROSS-REFERENCE TO RELATED APPLICATION(S)

This application claims the benefit of U.S. Provisional Patent Application No. 61/866,899, filed Aug. 16, 2013, which is incorporated herein by reference in its entirety for all purposes.

### BACKGROUND

Garden hoses and other lines, such as air hoses and power cords, are frequently used outdoors in residential and commercial settings. Reels conveniently locate and store the hoses and lines in a static location. Accordingly, the hoses and lines must be unreeled and their working ends taken to various points of use. One example is a residential garden hose that is unreeled and pulled across the user's backyard to water a small garden area in a distant corner of the yard. Oftentimes, a portion of the user's home or various landscaping features are positioned between the hose reel and the garden area. Accordingly, if the user simply pulls the hose from the reel to the garden, the hose will rub along the house or landscaping features. This can damage the hose, the house, and the landscaping features, let alone make unreeling the hose difficult or impossible.

Various attempts have been made to provide line guides that guide hoses and other lines along a path throughout a yard or other area of use. However, such attempts frequently fall short, due to a number of deficiencies. For example, many line guides do not anchor to the ground in a manner that is sufficiently stable to endure the pulling and friction forces incurred in a typical hose deployment. Many designs do not do a sufficient job containing the hose as it is pulled along its deployment path, causing the hose to become disengaged with the guide. Some designs do not adequately reduce the friction caused by the moving hose, which is a significant portion of the guide's purpose. Other designs are prominently positioned when deployed in a lawn, making them difficult to trim or mow around.

Accordingly, a new hose guide design is needed that is simple in design and effective in function. Such a design should be dependable, durable and easy to operate. Embodiments of the design should allow the user to trim or mow around easily when it is deployed in a yard.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

Various embodiments of the line guide of the present technology use a two part design. Some embodiments include an enclosure end portion and a mounting end portion. The enclosure end portion, in some embodiments, includes a rod that is provided in the shape of a shepherd's crook to define an open passage through the enclosure end portion. Low friction guide balls, with thru-holes, sized slightly larger than the bent rod, are positioned along the length of the guide portion around the open passage. The balls serve to prevent friction when a line, such as a garden hose, is pulled through the enclosure end portion. The mounting end portion includes an elongated mounting post that depends from the enclosure end portion. Embodiments of the technology further provide the mounting end portion with a base portion formed from a tube with a pointed mounting end and an open, flanged top end.

In some methods of use, the base is driven into the ground so that the flanged end is flush with the top of the ground. The mounting post of the enclosure end portion is passed through the open upper end of the base and into its open interior. In at least some embodiments, the enclosure end portion has the ability to rotate within the base, allowing it to turn and capture a hose that is pulled up against it. The user disposes a length of the line through the open passage of the enclosure end portion. In some methods of use, the line guide is positioned near an obstacle, which a user seeks to avoid when pulling the line along its pathway above the ground. The user then directs the line through the open passage of the enclosure end portion. As the user continues to pull the line along its pathway, the line comes into contact with the engagement end portion and at least one of a plurality of guide balls such that the line guide resists lateral movement of the line. A plurality of line guides may be used in spaced-apart succession along the pathway in order to avoid larger and/or multiple obstacles adjacent the pathway. When use of the hose is complete, the engagement end portions may be removed from the base portions, while leaving the base portions in the ground. This allows for standard use of the yard, including mowing, watering, and the like.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a perspective view of one embodiment of the line guide of the present technology and demonstrates one manner in which the guide portion and base portion may separate from one another.

FIG. 2 depicts a side elevation view of the line guide depicted in FIG. 1, in an assembled position.

FIG. 3 depicts a front elevation view of the line guide depicted in FIG. 1, in an assembled position.

FIG. 4 depicts a side elevation, cutaway view of the line guide depicted in FIG. 1, in an assembled position.

FIG. 5 depicts a perspective, exploded view of one embodiment of a guide portion that may be used with the line guide of the present technology.

FIG. 6 depicts a side elevation view of the line guide depicted in FIG. 1, and demonstrates one manner in which the guide portion may be aligned with the base portion after the base portion is inserted into the ground.

FIG. 7 depicts a perspective view of one manner in which multiple line guides of the present technology may be used to guide a length of electrical cord around an obstacle, such as a landscaping feature.

FIG. 8 depicts an isometric view of one manner in which the line guide may be used to guide a length of garden hose around an obstacle, such as a landscaping feature.

FIG. 9 depicts a perspective view of one manner in which the line guide may be used to guide a length of garden hose around an obstacle, such as a landscaping feature.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

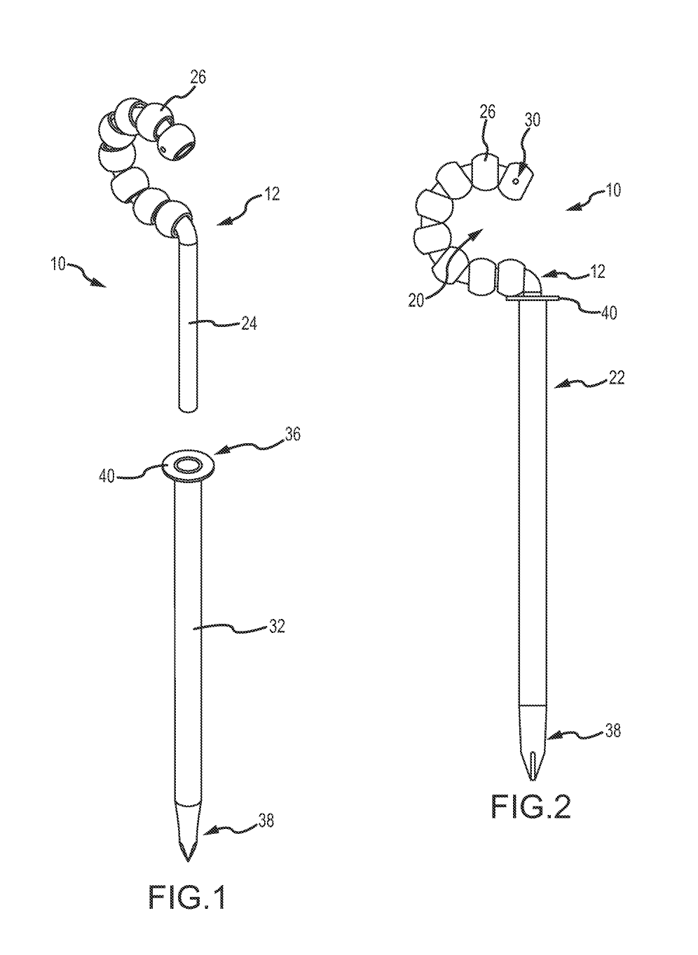

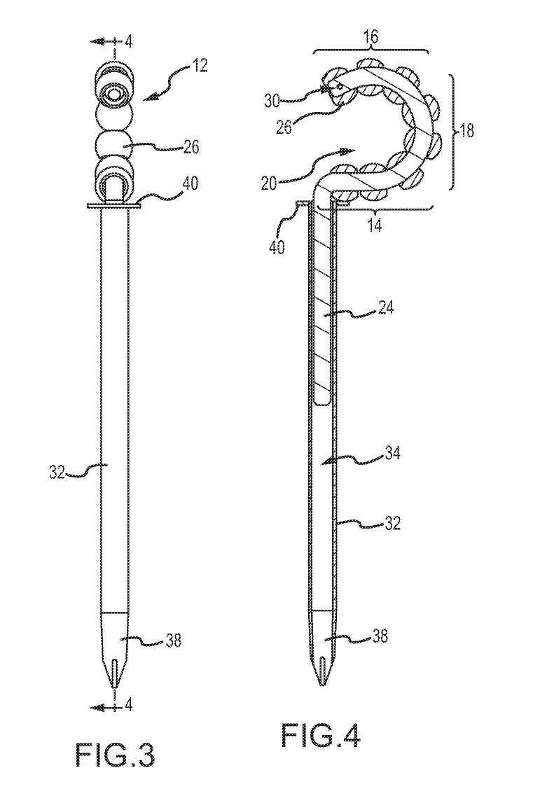

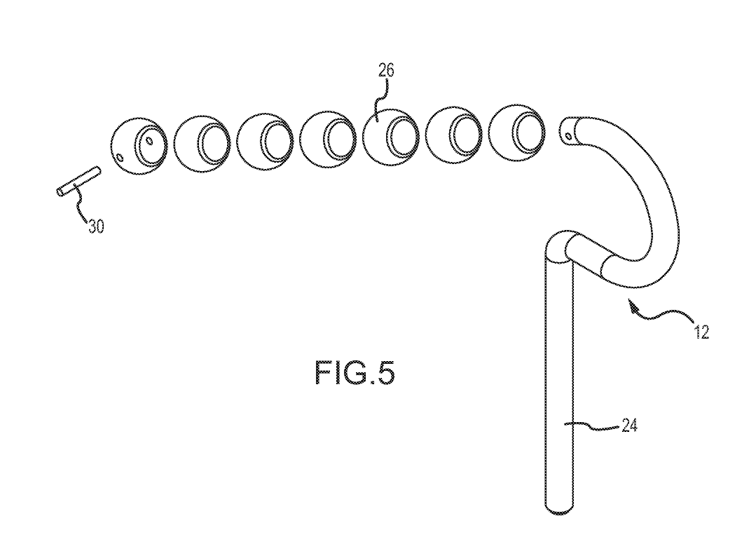

With reference to FIGS. 1-5, embodiments of the line guide 10 are presented to guide a line 2, such as a garden hose, electrical cord, and the like, along a pathway over an area of ground 4. Various embodiments of the line guide 10, of the present technology, includes an enclosure end portion 12 having a lower length 14, an upper length 16, and at least one side length 18 that define an open passage 20 through the enclosure end portion 12. In some embodiments, the enclosure end portion 12 is formed from a rod that is shaped to define the open passage 20. In at least one embodiment, the enclosure end portion 12 is generally C-shaped, such that the open passage 20 is open at one side. However, it is contemplated that one or more line guides 10 could be provided with two closed side lengths 18 and either an open lower length 14 or open upper length 16. Similarly, the enclosure end portion 12 is depicted as having portions that are curvilinear in shape, such that the enclosure end portion 12 is generally circular. Other curvilinear shapes, such as oval, obround, elliptical, and the like are contemplated to address the needs of particular intended uses. Likewise, it is contemplated that one or more lengths of the enclosure end portion 12 could be straight. To that end, depending on the needs of one or more intended uses, the enclosure end portion 12 could be polygonal, such as triangular, square, rectangular, etc. In at least some embodiments, the enclosure end portion 12 is provided with an outer diameter of approximately 3.75 inches and an inner diameter (defining a diameter of the open passage 20) of approximately 1.75 inches. In such embodiments, the open side portion of the enclosure end portion 12 has a length of approximately 1.5 inches, which is sufficient to accommodate the diameter of most lines 2 that are inserted into the open passage 20 from the side. In view of the outdoor nature of many intended uses, embodiments of the enclosure engagement portion 12 may be formed from a metal, including stainless steel.

A mounting end portion 22 depends from the lower length 14 of the enclosure end portion 12. The mounting end portion generally includes an elongated mounting post 24. While the mounting post 24 is depicted as being straight, it is contemplated that embodiments of the line guide 10 could include mounting posts of various shapes. For example, a mounting post 24 could be provided in a corkscrew shape, which could be beneficial for securely threading the line guide 10 into a mounting surface, such as an area of ground cover. It is contemplated that the mounting post 24 will, in various embodiments, be formed in uniform construction with the enclosure end portion 12. Accordingly, embodiments of the mounting post 24 will be formed from a rod of various materials, such as stainless steel.

With continued reference to FIGS. 1-5, a plurality of guide balls 26 are rotatably coupled with the enclosure end portion 12. In some embodiments, the guide balls 26 are low friction guide balls formed from acetal copolymer or similar low friction material. Each guide ball 26 includes a central passage 28 that axially penetrates the guide ball 26. The central passage is shaped to accommodate the passage of the rod from which the enclosure end portion 12 is formed. The guide ball positioned closest to the opening in the peripheral edge of the enclosure end portion 12 may be fitted with a locking pin 30 that secured the guide ball 26 to the enclosure end portion 12 and prevents the guide balls 26 from unintentionally becoming unthreaded from the enclosure end portion 12. In many embodiments, each of the lower length 14, upper length 16, and the side length 18 have at least one guide ball 26 rotatably coupled therewith. However, some embodiments will position a plurality of guide balls 26 per length of the enclosure end portion 12. In this manner, the line being passed through the line guide will contact the rotating guide balls 26 and not the static frame of the enclosure end portion 12. In some embodiments, the guide balls 26 are positioned to rotate independently or in conjunction with one or more adjoining guide balls 26. The guide balls 26 are depicted as being spherical in shape. This permits limited surface contact between the guide balls 26 and the line being pulled through the line guide 10, which limits friction and increases the ease with which the line is pulled through the line guide 10. However, other intended uses may permit the use of other shapes, such as cylindrical, or the like.

In some embodiments, the mounting end portion 22 of the line guide 10 includes an elongated base portion 32. The base portion 32 generally includes an open interior 34 extending between an open end portion 36 and a mounting end portion 38. The open end portion 36 and open interior 34 are shaped to removably receive a length of the elongated mounting post 24. In some embodiments, the fit between the mounting post 24 and the open interior 34 is sufficiently loose to permit rotation of the mounting post 24 and enclosure end portion 12 with respect to the base portion 32. In some such embodiments, the enclosure end portion 12 will rotate about a long axis of the base portion 32, sweeping a circular path having a diameter of approximately 6.25 inches. In other embodiments, it may be desirable to lock the position of the structures with respect to one another. It is contemplated that, in such instances, the mounting post 24 could be removably friction fit within the open interior 24 such that rotation is resisted but not prevented. A locking pin or other such mechanical fastener could be used to temporarily or permanently prevent rotation between the mounting post 24 and the base portion 32. It is contemplated that the base portion 32 will, in various embodiments, be formed from a durable material that can withstand extended periods disposed in the ground. Accordingly, embodiments of the base portion 32 are formed from corrosion resistant materials, such as stainless steel. Particular embodiments of the base portion 32 are provided with a length of approximately 12.75 inches. In some such embodiments, the mounting post 24 is provided with a length of approximately 5.5 inches. However, various different lengths for the mounting post 24 and base portion are contemplated for use with different ground and line types.

Embodiments of the base portion 32 will be shaped for easier insertion into, and removal from, various types of ground cover. Accordingly, embodiments of the base portion 32 include flange 40 that cantilevers outwardly from the open end 36. The flange 40 provides an engagement surface on which the base portion 32 may be pressed or repeatedly struck in order to insert the base portion 32 into the ground. The flange 40 further serves as a restraint to prevent disposing the base portion 32 too deeply into the ground and further provides a feature to engage when extracting the base portion 32 from the ground. Embodiments of the mounting end portion 38 of the base portion 32 are shaped as a pointed ground engagement tip to enhance the ability of the base portion 32 to penetrate hard ground cover.

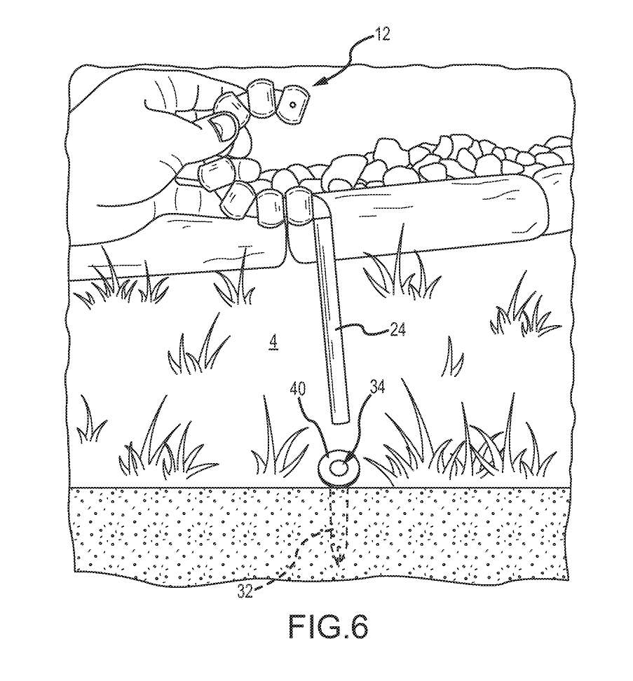

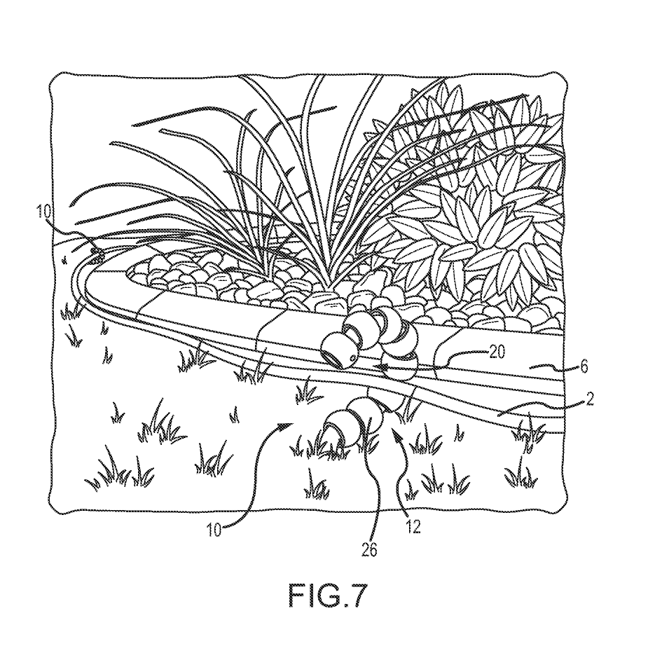

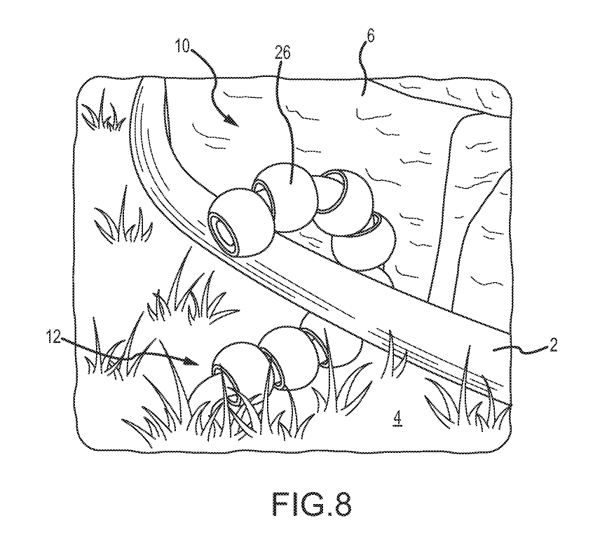

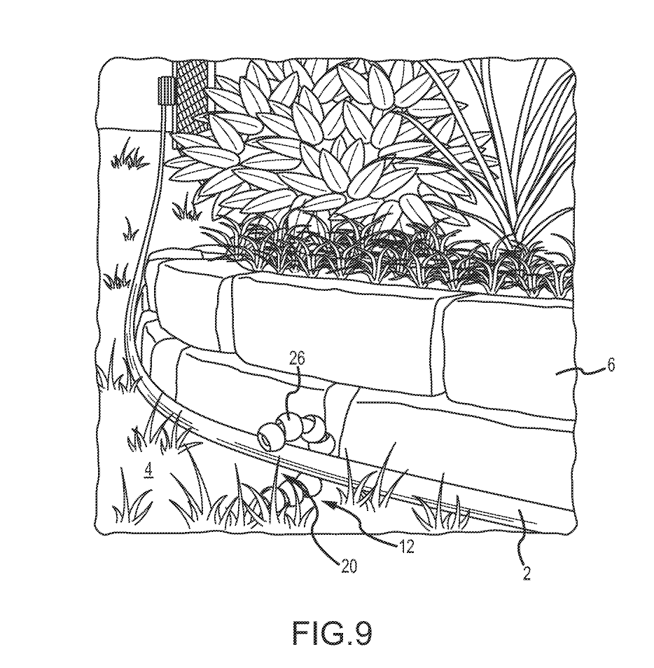

Methods of using the present technology are depicted, generally, in FIGS. 6-9. In at least one method of use, a user disposes at least a portion of a mounting end portion 22 of a line guide 10 into the ground 4, such that an enclosure end portion 12 of the line guide 10 is positioned at least substantially above the ground. In some embodiments, this may simply entail disposing the mounting post 24 directly into the ground 4. However, in other embodiments, the user disposes the mounting end portion 38 of a base portion 32 into the ground. The base portion 32 is advanced into the ground 4 until the flange 40 is positioned adjacent the ground 4. The user may then removably dispose the elongated mounting post 24 of the mounting end portion 22 through the open end 36 of the base portion 32 and into the open interior 34 of the base portion 32. It is contemplated that the user will position the line guide 10 near an obstacle, such as various landscaping features 6, plants, outdoor furniture, or the like, that the user seeks to avoid when pulling lengths of the line 2 along a pathway throughout a yard or other location of use. Where large obstacles or multiple obstacles are encountered, a plurality of line guides 10 may be used in conjunction with one another, horizontally spaced apart from one another, along the desired pathway.

Once the line guide 10 is disposed within the ground 4, the user may dispose a length of the line 2 through the open passage 20 of the enclosure end portion 12. The user then directs the length of line 2 through the open passage 20 of the enclosure end portion 12. When the line 2 engages the plurality of guide balls 26, the line guide 10 resists lateral movement of the line 2 with respect to the line guide 10 as it is directed through the open passage 20. In this manner, the line 2 is directed along the defined pathway and not into contact with the obstacles. Where rotation is structurally permitted between the enclosure end portion 12 and the base portion 32, contact between the line 2 and the guide balls 26 rotates the enclosure end portion 12 with respect to the base portion 32. This proves beneficial, by further reducing resistance between the line 2 and the line guide 10, as the user moves away from the line guide 10 at an angle.

Once the user no longer needs to use the line along its pathway through the yard, the user removes the line 2 from the open passages 20 of the line guides 10. The elongated mounting posts 24 may then be removed from within the open interiors 34 and open ends 36 of the base portions 32. Where desirable, the user may then remove the base portions 32 from the ground 4 by pulling or prying the flanges 40 away from the ground 4. However, the low profile of the base portions 32 (and corrosion resistant materials) enable them to be left in the ground 4. With the flanges 40 positioned closely adjacent the ground 4, the user is free to use the ground area for normal activities, such as lawn mowing, etc.

The line guide makes using a garden hose easier, while at the same time protecting plants, pots and outdoor furniture. The garden hose guide directs the hose around corners and obstacles that normally create wasted time and frustration. The long receiver tube drives in flush with the ground and accepts the removable hose guide rod. The Shepard's crook design pivots to capture the hose regardless of the direction the hose is pulled against it; this allows the user to pull the hose left or right and the guide will pivot to contain it. The “C” shape prevents the hose from slipping off. Low friction roller balls let the hose slip through the guide without resistance.

Although the technology been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A line guide comprising:
an enclosure end portion having a lower length, an upper length, and at least one side length that define an open passage through the enclosure end portion;
an elongated mounting end portion that depends from one end of the enclosure end portion; and
a plurality of guide balls rotatably coupled with the enclosure end portion such that each of the lower length, upper length, and at least one side length have at least one ball rotatably coupled therewith.

2. The line guide of claim 1 wherein:
the mounting end portion comprises an elongated mounting post and a base portion; the base portion having an open interior extending between an open end portion and a mounting end portion; the open end portion and interior being shaped to removably receive the elongated mounting post.

3. The line guide of claim 2 wherein:
the elongated mounting post is removably, rotatably disposed within the interior of the base portion.

4. The line guide of claim 2 further comprising:
a flange that extends outwardly from the open end portion of the base portion.

5. The line guide of claim 2 wherein:
the mounting end portion includes a pointed ground engagement tip.

6. The line guide of claim 1 wherein:
the enclosure end portion is generally C-shaped.

7. The line guide of claim 1 wherein:
the enclosure end portion is at least partially open at one side.

8. The line guide of claim 6 wherein:
portions of the enclosure end portion are curvilinear in shape.

9. A method of guiding a line along a pathway over an area of ground, the method comprising:
disposing at least a portion of a mounting end portion of a line guide into the ground, such that an enclosure end portion of the line guide is positioned at least substantially above the ground;
disposing a length of the line through an open passage of an enclosure end portion of the line guide, wherein the open passage is defined at least partially by a lower length, an upper length, and at least one side length of the enclosure end portion; and
directing the line through the open passage of the enclosure end portion such that the line engages at least one of a plurality of guide balls that are rotatably coupled with the enclosure end portion so that the line guide resists lateral movement of the line with respect to the line guide as it is directed through the open passage.
the guide portions may be removed from the base portions, leaving the base portions in the ground for future use.

10. The method of claim 9 wherein the step of disposing at least a portion of a mounting end portion of a line guide into the ground includes:
disposing a mounting end of a base portion of the mounting end portion into the ground; and
removably disposing an elongated mounting post of the mounting end portion through an open end of the base portion and into an interior of the base portion.

11. The method of claim 9 further comprising:
directing the line through the open passage of the enclosure end portion such that the line engages at least one of a plurality of guide balls and rotates the enclosure end portion with respect to the base portion.

12. The method of claim 9 wherein the step of disposing at least a portion of a mounting end portion of a line guide into the ground includes:
disposing mounting ends of base portions of a plurality of line guides into the ground in a horizontally spaced-apart manner with respect to one another, adjacent an obstacle positioned on the ground; and
removably disposing elongated mounting posts of mounting end portions of a plurality of line guides through open ends of the base portions and into interiors of the base portions.

13. The method of claim 12 further comprising:
directing the line through open passages of the enclosure end portions of the plurality of line guides along the pathway over the area of ground, at least partially around the obstacle.

14. The method of claim 13 further comprising:
directing the line through the open passages of the enclosure end portions such that the line engages at least one of a plurality of guide balls and rotates at least one of the plurality of enclosure end portions with respect to at least one of the base portions.

15. The method of claim 13 further comprising:
removing the line from the open passages of the enclosure end portions;
removing the elongated mounting posts from within the interiors and open ends of the base portions; and
leaving the base portions disposed within the ground.

16. A ground-based line guide comprising:
an enclosure end portion having an open passage; a plurality of guide balls rotatably coupled with the enclosure end portion such that elongated objects passing through the open passage may engage one or more of the guide balls and rotate the guide balls with respect to the enclosure end portion; and
an elongated mounting end portion, depending from one end of the enclosure end portion, and including an elongated mounting post and a base portion; the base portion having an open interior extending between an open end portion and a mounting end portion; the open end portion and interior being shaped to removably receive the elongated mounting post.

17. The ground-based line guide of claim 16 further comprising:
a flange that extends outwardly from the open end portion of the base portion.

18. The ground-based line guide of claim 16 wherein:
the mounting end portion includes a pointed ground engagement tip.

19. The ground-based line guide of claim 16 wherein:
the enclosure end portion is at least partially open at one side.

20. The ground-based line guide of claim 16 wherein:
portions of the enclosure end portion are curvilinear in shape.
